(19) United States
(12) Patent Application Publication
(10) Pub. No.: US 2009/0257332 A1
(43) Pub. Date: Oct. 15, 2009

(54) OPTICAL DISC READING APPARATUS AND METHOD THEREFORE

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN NETHERLANDS (NL)

(21) Appl. No.: 12/300,648

(22) PCT Filed: May 7, 2007
(86) PCT No.: PCT/IB07/51702

§ 371 Date: Nov. 13, 2008

(30) Foreign Application Priority Data
May 15, 2006 (EP) 06113915.0

(51) Int. Cl. G11B 20/18

(52) U.S. Cl. 369/53.16; G9B/20.046

(57) ABSTRACT

An optical disc reading apparatus, such as a Near Filed optical disc reading apparatus, comprises a disc reader (401) which generates a first signal by reading an optical disc (403). A bit detector (407) detects data values in response to the first signal and data reference signals which are indicative of expected signals for different data sequences. An air gap processor (415) generates a reading head position error signal indicative of a distance between the surface of the optical disc and a reading leans. A reference processor (409) modifies the data reference signals in response to the reading head position error signal. The invention allows improved bit detection and in particular allows fast adaptation of e.g. a Partial Response Maximum Likelihood (PRML) bit detector to variations in an air gap for a reading lens.

The invention relates to an optical disc reading apparatus and method of operation therefore and in particular, but not exclusively, to a Near Field optical disc reading apparatus.

Optical disc storage has proved to be an efficient, practical and reliable method of storing and distributing data as is evidenced by the popularity of storage disc formats such as Compact Discs (CDs) and Digital Versatile Discs (DVDs).

Continued research is undertaken to find ways to increase the capacity of optical discs and especially research and development continuously strives to provide higher data densities thereby allowing a higher capacity for a given sized disc.

One of the problems in increasing capacity is that the maximum data density that can be recorded on an optical disk in an optical recording system inversely scales with the size of the laser spot that is focused onto the disk. The spot size is determined by the ratio of two optical parameters: the wavelength λ of the laser and the Numerical Aperture (NA) of the objective lens. In conventional optics, this NA is limited to values smaller than 1.0. In so-called Near-Field systems, the NA can be made larger than 1.0 by applying a Solid Immersion Lens (SIL), thus allowing a further extension to larger storage densities. It is important to note that this NA>1 is only present within an extremely short distance (the so called Near-Field) from the exit surface of the SIL, typically smaller than 1/10^{th} of the wavelength of the light. This means that during writing or read-out of an optical disk, the distance between the SIL and disk must at all times be smaller than a few tens of nanometres. This distance is referred to as the air gap.

To allow accurate air gap control with a mechanical actuator at such small distances, a suitable error signal is required. As proposed in F. Zijp and Y. V. Martynov, “Optical Storage and Optical information processing”, Han-Ping D. Shieh, Tom D. Milster, Editors, Proceedings of Society of Photo-Optical Instrumentation Engineers Vol. 4081 (2000) pp. 21-27; (the International Society for Optical Engineering, Bellingham, Wash., 2000), ISSN 0277-786X/00; ISBN 0-8194-3720-4 and demonstrated in for example F. Zijp, M. B. van der Mark, J. I. Lee, C. A. Verschuren, B. H. W. Hendriks, M. L. M. Balistreri, H. P. Urbach, M. A. H. van der Aa, A. V. Padiy, “Optical Data Storage 2004”, edited by B. V. K. Vijaya Kumar, Hiromichi Kobori, Proceedings of Society of Photo-Optical Instrumentation Engineers Vol. 5380 (2004) pp. 209-223; (the International Society for Optical Engineering, Bellingham, Wash., 2004); ISSN 0277-786X/04, a good gap error signal (GES) is obtained from the reflected light with a polarization state perpendicular to that of the main beam that is focused on the disc. A significant fraction of the light becomes elliptically polarized after reflection at the SIL-air-disk interfaces: this creates a well-known Maltese cross effect when the reflected light is observed through a polarizer. The GES is generated by integrating all the light of this Maltese cross using polarizing optics and a single photo-detector.

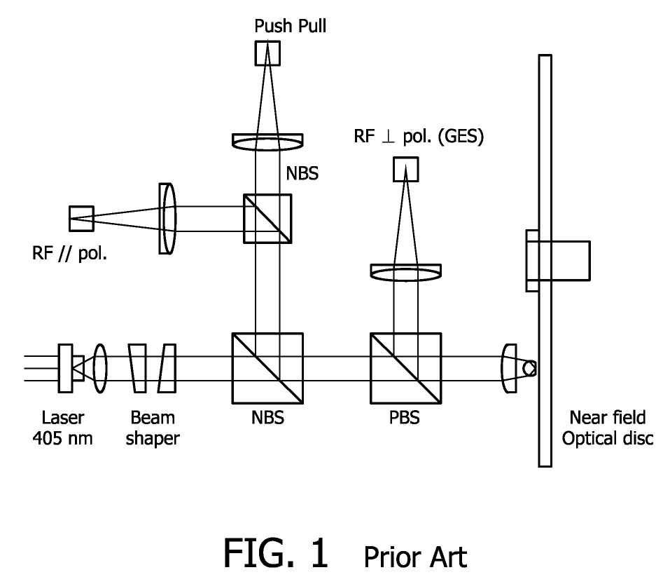

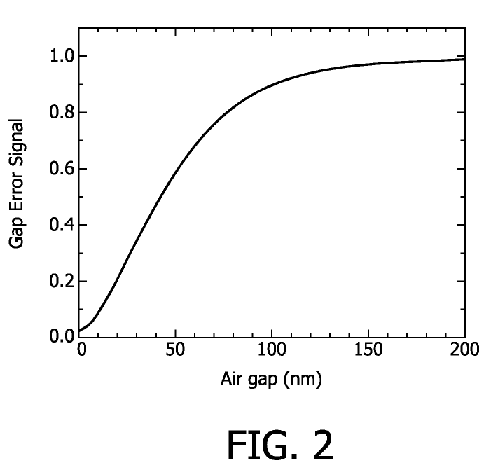

FIG. 1 illustrates an example of a Near-Field optical disc reader in accordance with prior art (PBS=polarizing beam splitter; NBS=non-polarizing beam splitter). FIG. 2 illustrates a calculated GES curve as a function of the air gap for an NA=1.9 lens and an optical disc with a phase change recording stack.

Even small changes in the air gap (say 1-5 nm) have a direct and significant impact on the spot intensity and quality, and therefore decrease the bit detection performance significantly. This is quite different from the conventional far-field optics where the dominant aberration is defocus. Due to the relatively small NA, the effect of small changes in the lens-to-disc distance, i.e. focus errors, is not important in this case. In near-field optics, the spot shape is determined by the efficiency of the evanescent coupling, as well as by significant polarization induced effects. These phenomena are strongly non-linear, but can be calculated for a given system configuration.

Thus, in such systems, residual air gap errors, e.g. occurring at high rotation speeds of the disc (to achieve a high data rate) have a strong effect on the properties of the optical spot. In most cases (but not always), the effect is negative (broader spot, larger aberrations) for increases in the air gap, and positive (narrower spot, smaller aberrations) for decreases in the air gap. Generally, the effect of the variations is that an increased number of errors are generated by the bit detector of the optical disc readers. Typically, error correction circuits (ECC) and methods are included which may substantially reduce the number of errors using some additional data on the disc.

However, an increased error rate may result. In particular, if air gap variations are larger than a certain amount, the bit detection circuit will yield a lot of erroneous data which the ECC may not be able to correct, leading to partial data loss. This is especially the case when the air gap variation is fast and abrupt, so that adaptive measures in the detection circuit cannot compensate in time.

Accordingly, the performance of the optical reader relies heavily on the error rate of the bit detection prior to the error correcting coding. A particularly efficient technique for detecting correct bit values in the presence of bit errors is known as Maximum Likelihood Sequence Estimation (MLSE) and specifically Partial Response Maximum Likelihood (PRML) bit detection. In particular, the Viterbi algorithm is commonly used for data extraction from storage media, such as optical discs, in the presence of media and electronics noise.

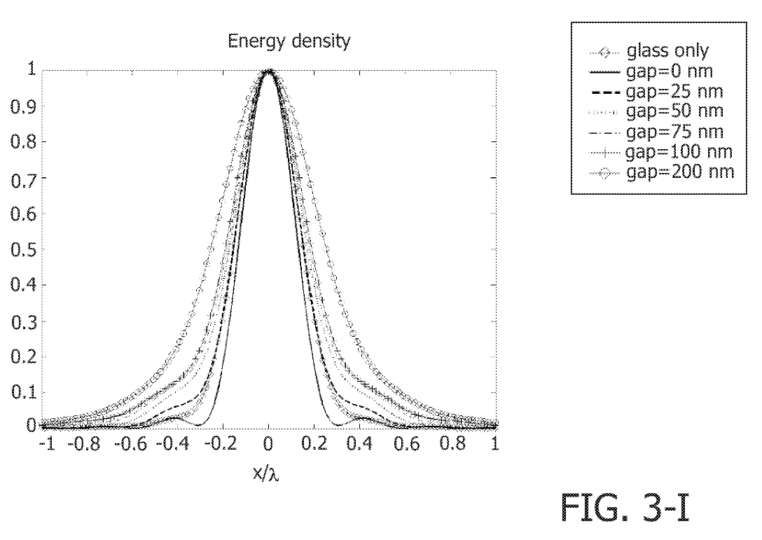

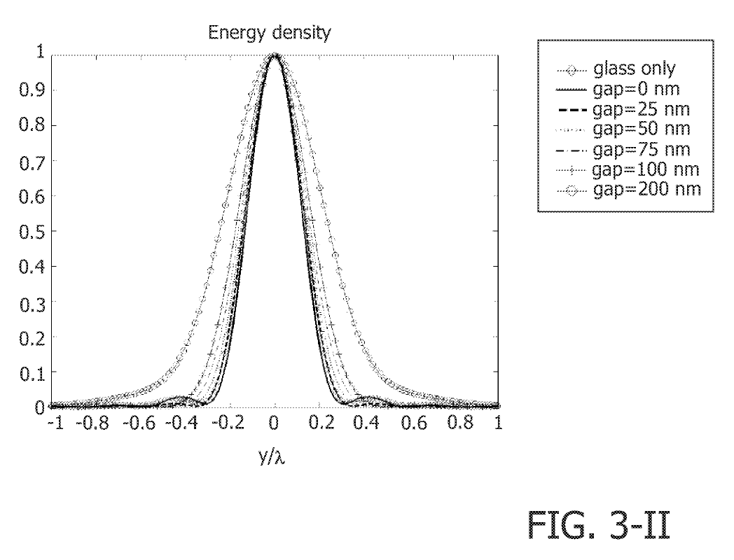

PRML detectors rely on determination of metric values for different possible data combinations. Each metric value is an indication of the noise free signal value corresponding to the data combination for which the metric is calculated. The metrics are determined by comparing the received signal from the optical disc with the expected signal values for the data combination. However, the size of the spot, and thus the inter-symbol interference and the expected response for a given data combination, strongly depends on the air gap of the system. FIG. 3 illustrates an example of the shape of a data spot as a function of the air gap. Specifically, the Figure illustrates normalized cross sections of the spot along (a) the x-axis and (b) the y-axis for several air gap widths between a SIL and a silicon disk, and for glass only without silicon disk. However, such variations in spot size and inter-symbol interference may result in increased detection error rates in a PRML detector.

Thus, in conventional optical disc readers, performance tends to be suboptimal and an improved optical disc reading would be advantageous and in particular an approach allowing reduced error rates, improved adaptation, facilitated implementation and/or improved performance would be advantageous.

Accordingly, the Invention seeks to preferably mitigate, alleviate or eliminate one or more of the above-mentioned disadvantages singly or in any combination.

According to a first aspect of the invention there is provided an optical disc reading apparatus comprising: a disc reader for generating a first signal by reading an optical disc; a bit detector for detecting data values in response to the first signal and data reference signals, the data reference signals being indicative of expected signals for different data sequences; impulse response characteristic for a reading channel of the disc reader; error signal means for generating a reading head position error signal; and modifying means for modifying the data reference signals in response to the reading head position error signal.

The invention may allow an improved optical disc reading apparatus. An improved error detection of data read from the optical disc may be achieved which may further allow the error rate of the generated output data to be reduced substantially. The invention may allow a low complexity implementation with improved performance. The invention may specifically allow a fast adaptation of data detection operations to the dynamic physical conditions.

The inventor has realized that the bit detection performance can degrade if e.g. an air gap deviates from a nominal value and that this performance can be improved by adapting the reference signals in response to an indication of the position of a reading element of the reader.

The reading head position error signal may be indicative of a position of a reading element of the optical disc reader, such as a lens for receiving the optical beam from the optical disc. Specifically, the reading head position error signal may be indicative of a position of a reading lens, such as a Solid Immersion Lens (SIL). The reading head position error signal may be an absolute value indicative of an absolute head position or a head position relative to e.g. a nominal position. The reading head position error signal may be indicative of a position of a reading element in one or more dimensions.

The bit detector may be arranged to generate a penalty metric in response to a comparison between the data reference signals and (at least parts of) the first signal. The data reference signals may reflect an expected value for the first signals for different data sequences. The data reference signals may correspond to reference levels for different data sequences and may be determined in response to an impulse response characteristic for the optical disc and/or the reading channel of the optical reader.

The bit detection may directly determine binary values or may determine bit values indirectly by determining values of non-binary data symbols.

According to an optional feature of the invention, the data reference signals comprise reference levels for different data sequences and the modifying means is arranged to modify at least one reference level in response to the reading head position error signal.

This may allow improved data detection correction and/or facilitated implementation. The reference levels may for example be automatically generated by Reference Level Units (RLUs).

According to an optional feature of the invention, the modifying means is arranged to modify the data reference signals to correspond to a wider impulse response for an increasing reading head position error signal.

This may allow improved data detection.

According to an optional feature of the invention, the reading head position error signal is a lens gap error signal

The invention may allow improved performance by allowing the bit detection operation to take into account the variations in the gap between a reading element and the optical disc. The invention may in particular allow fast variations in the gap to be taken into account by the bit detection. The lens gap error signal may be indicative of a distance between the surface of the optical disc and the reading element and may specifically be indicative of the air gap substantially perpendicular to the plane of the optical disc.

According to an optional feature of the invention, the error signal means is arranged to determine the head gap error signal in response to a measure of reflected light from the optical disc having a different polarity direction than a main beam.

This may allow improved bit detection and/or facilitated implementation.

According to an optional feature of the invention, the head position error signal is a relative signal indicative of a deviation from a nominal value.

This may allow improved bit detection and/or facilitated implementation.

According to an optional feature of the invention, the modifying means is arranged to compensate a nominal data reference signal by adding a compensating data reference signal value determined in response to the reading head position error signal.

This may allow improved bit detection and/or facilitated implementation.

According to an optional feature of the invention, the modifying means is arranged to determine the compensating data reference signal value in response to a predetermined unique relationship between the reading head position error signal and the compensating data reference signal value.

This may allow improved bit detection and/or facilitated implementation. The unique relationship may correspond to a one to one relationship between the reading head position error signal and the compensating data reference signal value. The unique relationship may for example be determined by measurements, calculations and/or simulations and may allow efficient and low complexity bit detection with high accuracy.

According to an optional feature of the invention, the modifying means is arranged to determine the data reference signals in response to a predetermined unique relationship between the reading head position error signal and the data reference signals.

This may allow improved bit detection and/or facilitated implementation. The unique relationship may correspond to a one to one relationship between the reading head position error signal and the data reference signals. The unique relationship may for example be determined by measurements, calculations and/or simulations and may allow efficient and/or low complexity bit detection with high accuracy.

According to an optional feature of the invention, the bit detector is arranged to perform a Partial Response Maximum Likelihood, PRML, bit detection.

The invention may allow improved bit detection for a PRML bit detector such as a Viterbi detector.

According to an optional feature of the invention, the optical disc reading apparatus is a Near Field optical disc reading apparatus.

The invention may allow an improved performance of a Near Field optical disc reading apparatus.

According to another aspect of the invention, there is provided a method of operation for an optical disc reading apparatus, the method comprising: generating a first signal by reading an optical disc; detecting data values in response to the first signal and data reference signals, the data reference signals being indicative of expected signals for different data sequences; generating a reading head position error signal; and modifying the data reference signals in response to the reading head position error signal.

These and other aspects, features and advantages of the invention will be apparent from and elucidated with reference to the embodiment(s) described hereinafter.

Embodiments of the invention will be described, by way of example only, with reference to the drawings, in which

FIG. 1 illustrates an example of a Near-Field optical disc reader in accordance with prior art;

FIG. 2 illustrates a calculated air gap error signal function of the air gap for Near-Field optical disc reader;

FIG. 3 illustrates an example of the shape of a data spot as a function of the air gap;

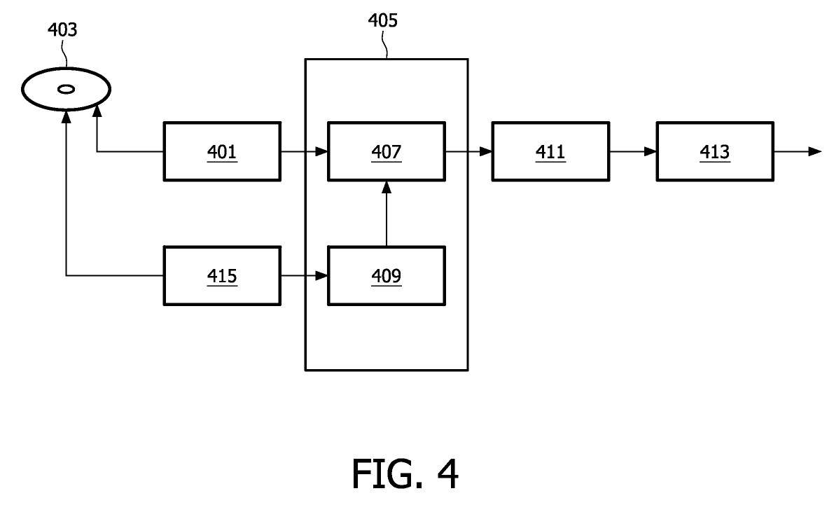

FIG. 4 illustrates an example of an optical disc reading apparatus in accordance with some embodiments of the invention; and

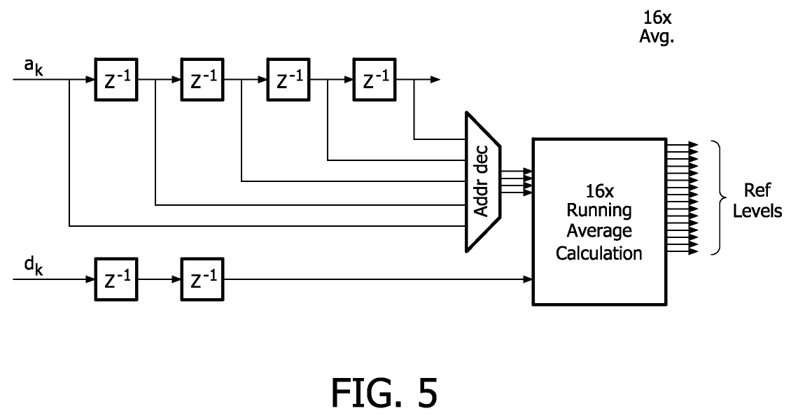

FIG. 5 illustrates an example of a Reference Level Unit for an optical disc reader.

The following description focuses on embodiments of the invention applicable to a Near Field optical disc reading apparatus. However, it will be appreciated that the invention is not limited to this application but may be applied to many other optical disc readers and systems.

FIG. 4 illustrates an example of an optical disc reading apparatus in accordance with some embodiments of the invention.

In the example, an optical disc data reader 401 reads data from an optical disc 403. The data stored on the optical disc 403 is RLL (Run Length Limited) coded. Furthermore, the optical disc data reader is a Near Field optical disc reader reading data from a high density optical disc 403. The optical disc data reader 401 specifically comprises a Solid Immersion Lens (SIL) which is controlled to be positioned very close to the surface of the disc. The reading head comprising the SIL is thus controlled such that the disc surface is within an extremely short distance (the so called Near-Field) from the exit surface of the SIL, typically smaller than 1/10^{th} of the wavelength of the light. Accordingly, the data is read with an NA>1 thereby allowing high data density on the disc. The data reader 401 generates an output signal which is a sampled representation of the analog signal read from the disc. Due to the inter-symbol interference introduced by the optical system, a given data sample comprises contributions from a plurality of data symbols surrounding the data sample.

The data samples read from the optical disc are fed from the optical disc data reader 401 to a bit detector 405 which is arranged to generate detected bit values corresponding to the data values stored on the optical disc 403. The bit detector 405 specifically comprises a Partial Response Maximum Likelihood (PRML) (or a Maximum Likelihood Sequence Estimator (MLSE)) detector 407 which determines the detected values in response to reference signals corresponding to expected signal values for different possible data sequences. Accordingly, the bit detector 405 comprises not only the PRML detector 407, which in the specific example is a Viterbi detector, but also a reference processor 409 which is coupled to the Viterbi detector 407 and which generates the reference signals.

The bit detector 405 is coupled to an error correction processor 411 and the detected data is fed to this. The error correction processor 411 performs additional error correction of the raw decoded data using redundant data of the optical disc. For example, the stored data may have been encoded using a Reed-Solomon error correcting scheme and the decoded data may be corrected by applying the corresponding decoding algorithm. Typically, in optical disc systems, user data is first encoded for error correction, and then modulation encoded according to the RLL code used. Upon read-out, the reverse processes are carried out: first RLL decoding followed by error correcting decoding to replay the user data.

The error correction processor 411 is coupled to a data interface 413 which interfaces to external equipment. For example, the data interface 413 may provide an interface to a personal computer.

Thus in the optical disc reader of FIG. 4, the Viterbi detector 407 performs an MLSE or PRML bit detection operation as is well known to the person skilled in the art.

In order to determine suitable metrics for the MLSE detection, the Viterbi detector 407 must have information of the expected signal values for the different possible data combinations. These reference signal values are generated by the reference processor 409. In the example, this information is generated as reference levels using a Reference Level Unit (RLU) which is comprised in the reference processor 409.

An RLU provides an automatic and implicit adaptation of a channel model to the measured system by determining an average value for all possible data combinations of a given length. Reference levels can be seen as the average value of the signal for a given modulation bit sequence.

An example of a possible implementation of a five-tap (considering five symbol value combinations) RLU is shown in FIG. 5. The (preliminary) detected modulation bits aₖ are entering together with the synchronised received signal dₖ. For each clock-cycle, 5 modulation bits are transformed into a 4 bit address, pointing to one of the 16 reference levels. This reference value is then updated by the value of the received dₖ. e.g. according to:

RLᵢ(k)=(1−α)×RLᵢ(k−1)+α×d(k)

where α is a suitable filter coefficient which is typically very small (e.g. around 0.01).

It will be appreciated that in this example, only 16 reference levels are considered for combinations of 5 data bits. However, due to the Run Length Limitation typically used on optical reading systems, the number of valid data combinations will be lower than the number of possible data combinations.

Thus, the RLU generates a low pass filtered or average signal value for different data bit combinations. For example, for an input sequence of 11111, the RLU maintains a reference value which corresponds to the average signal value that has previously been measured for this bit combination. Thus, the RLU inherently implements a channel model which indicates the expected signal value output from the channel for a given bit combination. This value is automatically generated and maintained as the low pass filtered value previously obtained. The reference level can thus be used by the Viterbi detector 407 to determine the path metrics.

As will be appreciated by the person skilled in the art, the operation of the RLU is based on explicit knowledge or assumptions of the correct data values and therefore the RLU may comprise a simple bit detector which generates preliminary data bits based on the received signal. Simple threshold detection is typically used for this purpose.

In order to ensure reliable reference values for the Viterbi detection, relatively long averaging intervals are often used for the RLU. However, in particular in Near Field systems, the distance between the optical disc surface and the SIL may vary quite rapidly due to the difficulty in controlling the reading head at such small distances. Furthermore, the impulse response of the system and thus the inter-symbol interference depends significantly on the air gap as illustrated in FIG. 3. Accordingly, the correct reference value can potentially deviate significantly from the reference values generated by the RLU resulting in a significant degradation of the PRML bit detection performance and thus the performance of the reading apparatus as a whole.

Specifically, although the error correction may be able to correct all errors at lower bit detection error rates, sudden variations in the air gap between the SIL and the disc surface may temporarily result in inaccurate reference values being applied and thus in bit detection rates that cannot be corrected by the error correction processor 411. Accordingly, air gap variations may lead to data loss at the output of the data reader.

Specifically, the inventor has realised that for PRML approaches, such as Viterbi detection, the performance degrades not only if the spot quality degrades, but also if the spot quality improves (as this is also a deviation from the expected value and therefore will be erroneously considered by the PRML bit detector). Known methods of PRML detection include the use of adaptive equalization filters or reference levels to dynamically modify the expected values in response to variations due to for example combat radial and tangential tilt as well as channel imperfections like asymmetry. However, these approaches are very slow and result in a degraded performance for relatively fast changes

In the data reader of FIG. 4, the optical disc reading apparatus furthermore comprises an air gap processor 415 which is arranged to generate a reading head position error signal which is indicative of a position of the reading lens (the SIL) which is used to read the data from the optical disc. Specifically, the reading head position error signal can be indicative of distance between a recording layer or surface of the optical disc and the SIL.

In the example, the air gap processor 415 comprises a sensor which is arranged to detect light reflected from the surface of the optical disc and having a different polarisation than the main beam. Specifically, the reflected light with a polarization state perpendicular to that of the main beam which is focused on the disc is detected and fed to a processing element of the air gap processor 415. An error signal is generated by integrating all the light of the Maltese cross pattern which results from the reflections of the disc when detected by using polarizing optics and a photo-detector. Specifically the air gap processor 415 can generate relative or absolute reading head position error signals.

For example, the error signal can directly indicate the amount of detected light which may be considered as a direct indication of the distance between the optical disc surface and the SIL. As another example, the error signal can indicate a deviation from a nominal distance between the optical disc surface and the SIL. E.g. the preferred air gap between the optical disc surface and the SIL may be 10 nm. The amount of light detected for this distance may be stored in the air gap processor 415 as a reference. The difference between the currently detected light and the reference value can then be determined and used as an indication of the deviation from the nominal distance. It will be appreciated that in some embodiments such a difference signal may be used directly whereas in other embodiments it may further be processed to provide a preferred characteristic (e.g. a non-linear function, such as a logarithmic function, may be applied).

The air gap processor 415 is coupled to the bit detector 405 and is specifically coupled to the reference processor 409. In operation, the reference processor 409 is arranged to modify the generated reference signals depending on the value of the reading head position error signal received from the air gap processor 415.

The reference processor 409 can thus modify the generated reference signals such that they more accurately reflect the actual signals which are received from the optical disc reader 401. For example, when the air gap increases the inter-symbol interference from a given data symbol on the optical disc 403 will increase and this effect may be used to modify the reference signals accordingly. Similarly, when the air gap decreases the inter-symbol interference will be reduced and the reference signals may be modified to reflect this.

Thus, in the optical disc reader of FIG. 4, the sampled gap error signal can be used to feed forward updated values for the reference levels to the PRML detector 407. In this way, the operation of the PRML detector 407 can quickly correct for the air gap variation effects. This may provide a substantial improvement for non-adaptive detectors but may also improve performance for adaptive detector configurations as the adaptation may be much faster than adaptations to other effects and may specifically be sufficiently fast to compensate for the air gap variation. Thus faster and more stable adaptation to air gap variations can be achieved.

As a specific example, the air gap processor 415 can be arranged to modify the reference levels generated by the RLU by adding a compensating data reference signal value determined in response to the reading head position error signal. The compensating data value may specifically be generated from a reading head position error signal which is indicative of a deviation from a nominal value.

Specifically, the RLU may be arranged to operate with a high averaging time which will result in accurate long-term reference values that correspond to the average air gap. For example, the reading head may be controlled such that the SIL is on average 30 nm from the surface of the disc. The reference levels generated by the RLU will thus correspond to an average response when the air gap distance is 30 nm. However, the exact distance between the surface of the disc and the SIL may fluctuate significantly (say ±5 nm) and this fluctuation may be much faster than the averaging interval. In the example, the air gap processor 415 generates a relative signal which is indicative of the deviation of the air gap from the nominal value of 30 nm. For example, when the air gap reduces a negative error signal may be generated and when the air gap increases a positive error signal may be generated.

The reference processor 409 processes the received error signal to generate compensating values that will be added to the determined reference levels. The compensating data values are calculated such that they correspond to the deviation in the air gap indicated by the reading head position error signal. For example, if the air gap increases to 31 nm, the inter-symbol interference for each individual symbol will increase. The effect of a given increase in the inter-symbol interference will be different for the different data sequences and therefore different for the different reference levels. However, for a given reference level the impact can be determined relatively accurately and therefore the reference processor 409 can determine a compensating value corresponding to this air gap for each of the reference levels. The determined compensating values are then added to each of the reference values thereby modifying this to more accurately reflect the expected signal levels for the different data sequences.

Thus, in such an embodiment, a relative air gap error signal, such as a deviation of the air gap from a nominal air gap, is directly translated into specific correction values to be applied to the determined average reference levels. Such an approach has the advantage that reference level value corrections originating from other adaptive circuits for other effects than air gap variations (such as channel asymmetry, tilt etc.) are not affected. Furthermore, the approach allows a low complexity, accurate and fast determination of reference values which reflect the impact of air gap variations. Accordingly, significantly improved bit detection with substantially reduced error rate can be achieved.

The compensating values can be determined in response to a predetermined unique relationship between the reading head position error signal and the compensating data reference signal value. For example, predetermined compensating values can be stored in parametric form as a function of the error signal (corresponding to an actual air gap relative to the nominal air gap), or can be obtained by table look-up and e.g. interpolation from tabulated values. The predetermined compensating values can be derived by calculation (offline, taking optical geometry and disc stack into account), from simulations or from dedicated experiments.

The above examples focused on an optical data reader wherein an adaptive RLU was used to determine reference values that were consequently compensated in response to an error signal being indicative of the deviation of an air gap from a nominal value. However, it will be appreciated that other approaches may be used.

For example, an absolute reading head position error signal may be generated which has a value that is directly indicative of the size of the air gap. For example, the amount of detected light by the air gap processor 415 may be used directly without reference to a nominal or expected value. Thus, the error signal may simply have an increasing value for an increasing air gap.

In some embodiments, the data reference signals may be determined directly in response to the reading head position error signal. For example, an air gap value indicated by the error signal may set to directly correspond to a set of impulse response or reference level values. Thus, the reference processor 409 can simply determine the data reference signals in response to a predetermined unique relationship between the reading head position error signal and the data reference signals. As a simple example, the reference processor 409 can comprise a look-up table which for each possible value of a suitably quantised reading head position error signal contains a set of reference level values. Such a system may provide efficient bit detection while ensuring that the complexity is low.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An optical disc reading apparatus comprising:
a disc reader (401) for generating a first signal by reading an optical disc (403);
a bit detector (407) for detecting data values in response to the first signal and data reference signals, the data reference signals being indicative of expected signals for different data sequences;
error signal means (415) for generating a reading head position error signal; and
modifying means (409) for modifying the data reference signals in response to the reading head position error signal.

2. The optical disc reading apparatus of claim 1 wherein the data reference signals comprise reference levels for different data sequences and the modifying means (409) is arranged to modify at least one reference level in response to the reading head position error signal.

3. The optical disc reading apparatus of claim 1 wherein the modifying means (409) is arranged to modify the data reference signals to correspond to a wider impulse response for an increasing reading head position error signal.

4. The optical disc reading apparatus of claim 1 wherein the reading head position error signal is a lens gap error signal

5. The optical disc reading apparatus of claim 4 wherein the error signal means (415) is arranged to determine the lens gap error signal in response to a measure of reflected light from the optical disc having a different polarity direction than a main beam.

6. The optical disc reading apparatus of claim 1 wherein head position error signal is a relative signal indicative of a deviation from a nominal value.

7. The optical disc reading apparatus of claim 1 wherein the modifying means (409) is arranged to compensate a nominal data reference signal by adding a compensating data reference signal value determined in response to the reading head position error signal.

8. The optical disc reading apparatus of claim 7 wherein the modifying means (409) is arranged to determine the compensating data reference signal value in response to a predetermined unique relationship between the reading head position error signal and the compensating data reference signal value.

9. The optical disc reading apparatus of claim 7 wherein the modifying means (409) is arranged to determine the data reference signals in response to a predetermined unique relationship between the reading head position error signal and the data reference signals.

10. The optical disc reading apparatus of claim 1 wherein the bit detector (407) is arranged to perform a Partial Response Maximum Likelihood, PRML, bit detection.

11. The optical disc reading apparatus of claim 1 wherein the optical disc reading apparatus is a Near Field optical disc reading apparatus.

12. A method of operation for an optical disc reading apparatus, the method comprising:
generating a first signal by reading an optical disc (403);
detecting data values in response to the first signal and data reference signals, the data reference signals being indicative of expected signals for different data sequences; generating a reading head position error signal; and
modifying the data reference signals in response to the reading head position error signal.
